(19) United States
(12) Patent Application Publication
(10) Pub. No.: US 2018/0267746 A1
(43) Pub. Date: Sep. 20, 2018

(54) READOUT CONTROL DEVICE, STORAGE CONTROLLER, AND COMPUTER PROGRAM PRODUCT

(71) Applicant: Kabushiki Kaisha Toshiba, Tokyo (JP)

(72) Inventors: Takayuki ITOH, Kawasaki (JP); Atsushi MATSUMURA, Yokohama (JP); Tomoya KODAMA, Kawasaki (JP)

(73) Assignee: Kabushiki Kaisha Toshiba, Tokyo (JP)

(21) Appl. No.: 15/684,975

(22) Filed: Aug. 24, 2017

(30) Foreign Application Priority Data
Mar. 15, 2017 (JP) 2017-049946

(51) Int. Cl. G06F 3/06; G06F 12/02; G06F 11/08

(52) U.S. Cl. CPC G06F 3/0679; G06F 11/08; G06F 12/0246

(57) ABSTRACT

According to an embodiment, a readout control device includes a memory and one or more processors configured to function as a converter, a reader and an analyzer. The converter converts a logical address of a compressed cluster that is a readout target into a physical address in a non-volatile memory. The reader reads out, from the non-volatile memory, data included in a packing unit at a position indicated by the physical address. The analyzer analyzes header information included in the packing unit, in parallel to reading of the data included in the packing unit, and acquires position information of the compressed cluster that is the readout target in the packing unit.

### CROSS-REFERENCE TO RELATED APPLICATIONS

This application is based upon and claims the benefit of priority from Japanese Patent Application No. 2017-049946, filed on Mar. 15, 2017; the entire contents of which are incorporated herein by reference.

### FIELD

Embodiments described herein relate generally to a readout control device, a storage controller, and a computer program product.

### BACKGROUND

Storage devices that use a non-volatile memory such as a NAND flash are used. These storage devices store externally input data in the non-volatile memory, and also, store a correspondence relationship between a physical address of a storage destination and a logical address which can be referred to from outside. In the case of reading out information, data stored in the non-volatile memory is read out by using a physical address corresponding to a logical address of the readout target data, and the data is output to outside. Data is stored in the non-volatile memory in units of clusters of a predetermined size, and association with a physical address is performed on a per cluster basis.

In relation to such a storage device, there is known a technology of storing a compressed cluster obtained by compressing data in the non-volatile memory. There is also indicated a method of holding of a part of the position and size information of a compressed cluster in an error-correcting code (ECC) unit, which is a data unit to which ECC is applied. However, conventionally, a process of reading out a readout target ECC unit, acquiring position and size information of a compressed cluster included in the ECC unit which has been read out, and further reading out ECC units of a required number is necessary. Accordingly, conventionally, there are problems that a delay time of readout at the time of random access is increased, and that the access speed to the non-volatile memory is reduced.

### BRIEF DESCRIPTION OF THE DRAWINGS

FIG. 1 is a schematic diagram of a storage device;

FIG. 2 is a schematic diagram illustrating a data structure of a packing unit;

FIG. 3 is a schematic diagram illustrating a data structure of header information;

FIG. 4 is a schematic diagram illustrating a data structure of header information;

FIG. 5 is a schematic diagram illustrating a data structure of header information;

FIG. 6 is an explanatory diagram for readout control;

FIG. 7 is an explanatory diagram for readout and analysis of data;

FIG. 8 is an explanatory diagram for readout and analysis of data;

FIG. 9 is a flowchart illustrating a procedure of a write process;

FIG. 10 is a flowchart illustrating a procedure of a readout process;

FIG. 11 is a schematic diagram of a storage device;

FIG. 12 is an explanatory diagram for readout and analysis of data;

FIG. 13 is an explanatory diagram for readout and analysis of data; and

FIG. 14 is a hardware configuration diagram.

### DETAILED DESCRIPTION

According to an embodiment, a readout control device includes a memory and one or more processors configured to function as a converter, a reader and an analyzer. The converter converts a logical address of a compressed cluster that is a readout target into a physical address in a non-volatile memory. The reader reads out, from the non-volatile memory, data included in a packing unit at a position indicated by the physical address. The analyzer analyzes header information included in the packing unit, in parallel to reading of the data included in the packing unit, and acquires position information of the compressed cluster that is the readout target in the packing unit.

Hereinafter, a readout control device, a storage controller, and a computer program product will be described in detail with reference to the appended drawings.

### First Embodiment

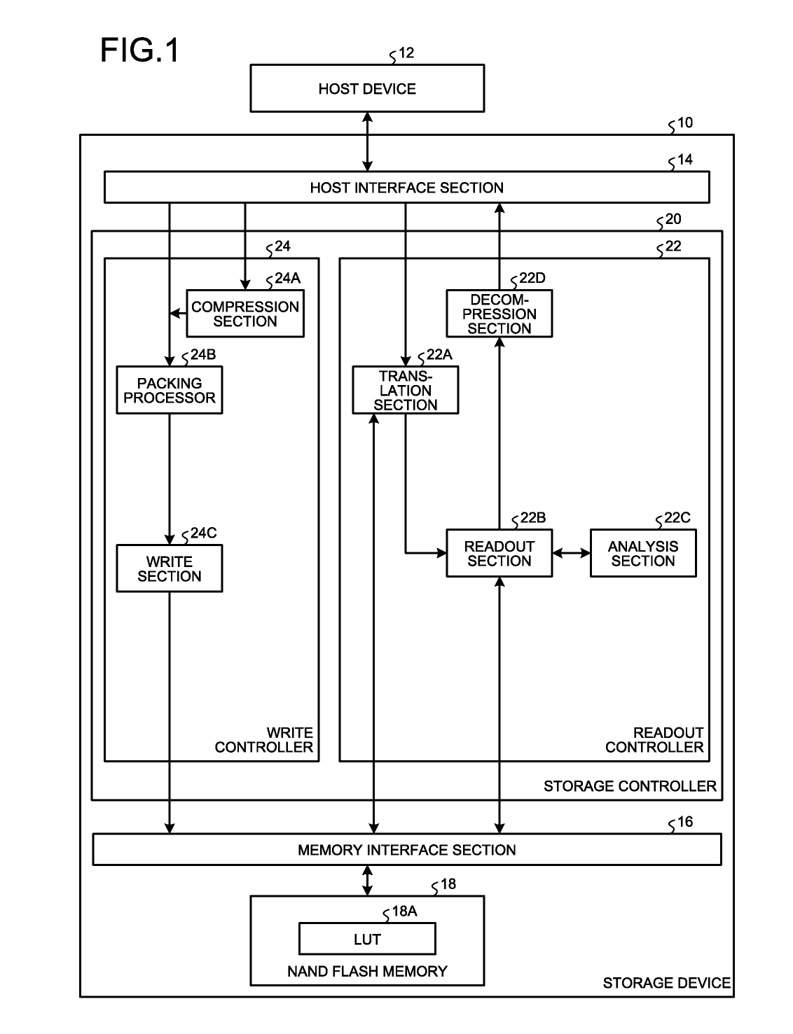

FIG. 1 is a schematic diagram illustrating an example of a storage device 10 according to a present embodiment.

The storage device 10 is a storage device that uses a non-volatile memory. For example, the storage device 10 is a solid state drive (SSD).

The storage device 10 is communicatively connected to a host device 12. For example, the storage device 10 and the host device 12 are connected by an interface standard such as serial AT attachment (SATA), a serial attached SCSI (SAS) or a peripheral component interconnect express (PCIe).

The host device 12 is an information processing apparatus such as a personal computer (PC), a workstation or a server device. The host device 12 requests the storage device 10 for writing of data, reading of data, and the like.

The storage device 10 includes a host interface section 14, a storage controller 20, a memory interface section 16, and a NAND flash memory 18.

The host interface section 14 is an interface for connecting the storage controller 20 and the host device 12. The storage controller 20 is connected to the host device 12 via the host interface section 14.

The memory interface section 16 is an interface for connecting the storage controller 20 and the NAND flash memory 18. The storage controller 20 is connected to the NAND flash memory 18 via the memory interface section 16.

The NAND flash memory 18 is an example of a non-volatile memory.

The storage controller 20 performs write control and readout control on the NAND flash memory 18.

The NAND flash memory 18 includes storage elements (referred to as “cells”). A region (each of cell arrays) of the storage elements of the NAND flash memory 18 stores one-bit or multi-bit information.

Readout control and write control of data in the NAND flash memory 18 is performed on a per physical page basis. A physical page includes a predetermined number of a plurality of cells. Moreover, deletion from the NAND flash memory 18 is performed on a per physical block basis. A physical block includes a predetermined number of a plurality of physical pages. The size of a physical page is 4 kbytes, 8 kbytes, or 16 kbytes, for example.

The NAND flash memory 18 includes a data buffer. The data buffer is sometimes referred to as a page register.

In the case of reading out data from the NAND flash memory 18, first, data on a specified physical page is read from the cell array into the data buffer. Then, the data in the data buffer is output to the storage controller 20 via a data bus and the memory interface section 16.

For example, also in the case of reading out a part of data on a physical page in the NAND flash memory 18, readout from the cell array into the data buffer is performed on a per physical page basis.

On the other hand, output of data from the data buffer to the storage controller 20 is a sequential transfer process via the data bus, and transfer of any portion or only a designated portion may be performed.

Writing of data into the NAND flash memory 18 is also performed via the data buffer. In the case of performing writing, write data is transferred to the data buffer from the storage controller 20, via the memory interface section 16 and a data port of the NAND flash memory 18. Then, contents of the data buffer are written into a specified physical page in the cell array.

Next, a description will be given on the storage controller 20. The storage controller 20 is a control device for performing data write control and data readout control on the NAND flash memory 18. The storage controller 20 is configured from one or a plurality of large scale integrated circuits (LSIs).

The storage controller 20 includes a write controller 24, and a readout controller 22. The host interface section 14, the memory interface section 16, the readout controller 22, and the write controller 24 are communicatively interconnected by buses such as an address bus and a data bus.

The write controller 24 includes a compression section 24A, a packing processor 24B, and a write section 24C. The readout controller 22 includes a translation section 22A, a readout section 22B, an analysis section 22C, and an expansion section 22D. For example, the readout controller 22, the translation section 22A, the readout section 22B, the analysis section 22C, the decompression section 22D, the write controller 24, the compression section 24A, the packing processor 24B, and the write section 24C are realized by one or a plurality of processors. For example, each of the sections mentioned above may alternatively be realized by causing a processor such as a central processing unit (CPU) to execute a program, that is, by software. Each of the sections mentioned above may alternatively be realized by a processor such as a dedicated integrated circuit (IC), that is, by hardware. Each of the sections mentioned above may alternatively be realized by a combination of software and hardware. In the case of using a plurality of processors, each processor may realize one of the sections, or two or more of the sections.

Additionally, the term “processor” used in the present embodiment and an embodiment described below refers to a CPU, a graphical processing unit (GPU), or a circuit such as an application specific integrated circuit (ASIC) or a programmable logic device (such as a simple programmable logic device (SPLD), a complex programmable logic device (CPLD), or a field programmable gate array (FPGA)).

The processor realizes each of the sections mentioned above by reading out a program saved in a storage section and by executing the program. Additionally, instead of saving a program in the storage section, the program may be directly embedded in the circuit of the processor. In this case, the processor reads out and executes the program embedded in the circuit to realize each of the sections mentioned above.

The write controller 24 compresses and packs write data received from the host device 12, and performs write control of writing the data into the NAND flash memory 18.

The write controller 24 includes the compression section 24A, the packing processor 24B, and the write section 24C.

The write controller 24 receives a write request from the host device 12. A write request includes write target data, and a logical address (LBA: logical block address). For example, the LBA is a logical block address that can be referred to from outside (such as the host device 12). The LBA is an address that takes a sector of 512 bytes as a unit, for example

The compression section 24A acquires the write target data included in the write request. In the present embodiment, the write target data in a predetermined unit (cluster) is included in the write request. A cluster is a collection of data of a predetermined size (such as 4 kbytes). In the case where the unit of cluster is one sector, the cluster and the sector are equivalents, and an LCA and the LBA are equivalents.

The compression section 24A compresses the write target data on a per cluster basis, and generates a compressed cluster.

The size of write target data included in a write request is sometimes larger than the cluster. In such a case, the compression section 24A may divide the write target data into clusters, and generate a compressed cluster for each of the clusters obtained by division.

The compression section 24A performs, on a cluster, a compression process that is based on a lossless compression method. For example, the compression process may be Lempel-Ziv (LZ77, LZ78, etc.), Deflate, or various other types of dictionary-based compression. Also, the compression section 24A may perform the compression process by block sorting coding (such as bzip2) or various types of entropy coding. The compression section 24A outputs a compressed cluster generated by compressing a cluster to the packing processor 24B.

Additionally, a compressed cluster generated by the compression process has a smaller data size compared to the cluster before compression (the compression rate is at or above a threshold).

However, depending on the property of the data of a cluster or the compression method, the compression rate of a compressed cluster after compression to the cluster may be below the threshold. That is, the data size is sometimes not reduced or is increased even when the compression process is performed.

Accordingly, in the case where the compression rate is below the threshold, the compression section 24A may output, to the packing processor 24B, the original cluster and a flag indicating non-compression, instead of the compressed cluster. As the threshold for the compression rate, a compression rate by which the total of increase/decrease in the amount of delay in the reading of data from the NAND flash memory 18 becomes negative (decrease) may be set in advance. This may prevent an increase in the data size caused by compression.

Next, a description will be given on the packing processor 24B.

The packing processor 24B acquires a compressed cluster from the compression section 24A. Also, the packing processor 24B acquires a logical address of the compressed cluster. The packing processor 24B acquires the logical address by reading a logical address included in the write request.

The packing processor 24B generates a packing unit. A packing unit includes one or a plurality of compressed clusters, and header information.

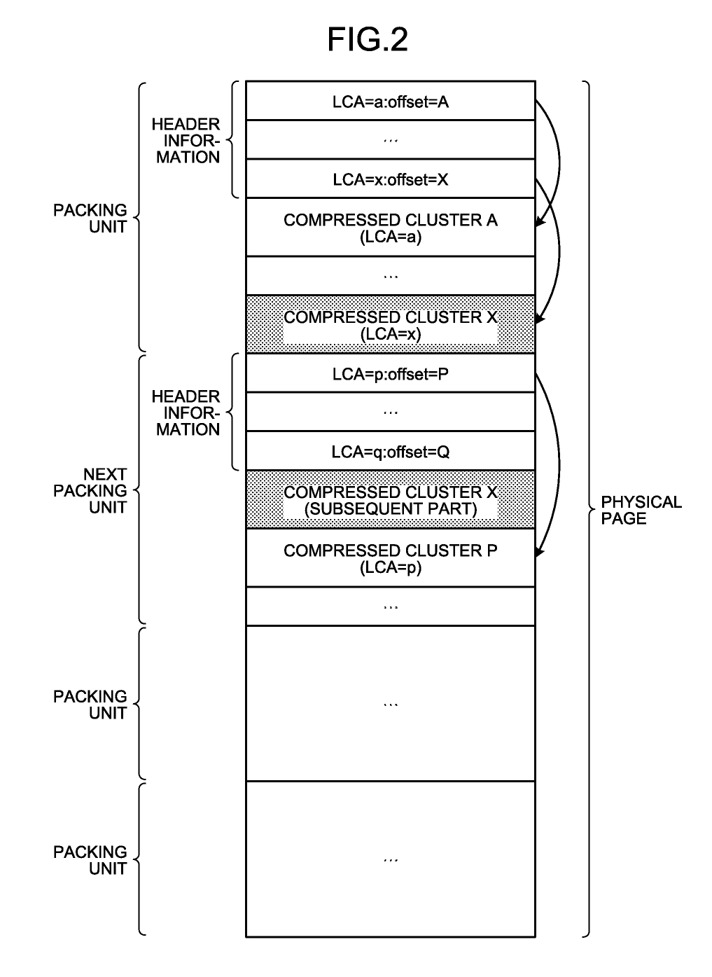

FIG. 2 is a schematic diagram illustrating an example of a data structure of a packing unit. Additionally, FIG. 2 illustrates, as an example, a plurality of packing units included in a physical page in the NAND flash memory 18.

A packing unit includes header information and one or more compressed clusters (or a part thereof). The data size of the packing unit may be determined in advance. For example, the data size of the packing unit may be equal to or smaller than the size of the physical page. Furthermore, a physical page may include one or more packing units. Moreover, the size of a packing unit may be equal to the size of the cluster (cluster before compression), for example.

The packing processor 24B sequentially arranges compressed clusters acquired from the compression section 24A from immediately after the header information of the packing unit. For example, in the case where a compressed cluster is already arranged in an arrangement target packing unit, the packing processor 24B arranges a currently acquired compressed cluster immediately after the previously acquired compressed cluster. In the case where the end of the arranged compressed cluster does not fit in the arrangement target packing unit, the packing processor 24B arranges the unfitted part at the beginning of the next packing unit (immediately after the header information).

Furthermore, the packing processor 24B registers information about a compressed cluster the beginning position of which is included in the packing unit, in the header information of the packing unit.

More specifically, header information is information at least associating the logical address of a compressed cluster included in the packing unit including the header information, and position information (hereinafter referred to also as “offset”) indicating the position of the compressed cluster in the packing unit. The position information is a type of physical address.

By associating, and holding, in the header information, the logical address (LCA: logical cluster address) of a compressed cluster and the offset of the compressed cluster, even if a plurality of compressed clusters are included in a packing unit, the position information (offset) of a target compressed cluster may be easily acquired based on the logical address (LCA).

In the present embodiment, the packing processor 24B stores the LCA in the header information, as the logical address of a compressed cluster. The LCA is a part, of the LBA of the compressed cluster, corresponding to the beginning address (the high order bit portion of the LBA).

The packing processor 24B outputs a packing unit including the header information and a compressed cluster to the write section 24C.

Additionally, the packing processor 24B may arrange, in a packing unit, compressed clusters acquired from the compression section 24A in units of bytes with no space between the clusters. Also, the packing processor 24B may generate packing units by arranging the beginnings of compressed clusters at positions corresponding to units of a predetermined size (such as 64 bytes or 512 bytes) in the packing units.

In the case of arranging beginnings of compressed clusters at positions corresponding to units of a predetermined size, the size of a compressed cluster is sometimes smaller than the unit. In such a case, the packing processor 24B may perform a padding process from the end of the compressed cluster to a position corresponding to the next unit. A padding process is a process of filling an empty region by zero or arbitrary data.

If the packing processor 24B uses a unit of byte or a unit of a smaller size as the unit of the predetermined size, an increase in the data by packing may be suppressed. On the other hand, if the packing processor 24B uses a unit of the predetermined size which is a larger size, the amount of data of the header information may be reduced.

Additionally, the packing processor 24B may set in advance a maximum value for the compressed clusters that can be packed in one packing unit. The packing processor 24B may generate one packing unit by the number of compressed clusters corresponding to the maximum value. Furthermore, after one packing unit is generated by the number of compressed clusters of the maximum value, a compressed cluster that is acquired next may be assigned to the next packing unit.

Additionally, the end of a compressed cluster arranged at the end of a packing unit at the end of a physical block in the NAND flash memory 18 sometimes does not fit in the packing unit.

Deletion from the NAND flash memory 18 is performed on a per physical block basis. Accordingly, if one compressed cluster is arranged across a plurality of physical blocks, deletion efficiency of physical block or processing efficiency regarding reuse of physical block (garbage collection (GC) processing) is reduced.

Accordingly, in such a case, the packing processor 24B may not arrange the compressed cluster in the packing unit, but in a packing unit on the next physical block. Additionally, the next physical block is another physical block which is the next write destination. Due to the GC processing, the next physical block does not have to be according to the order of addresses.

By performing a packing process on a compressed cluster in the above manner, although the packing efficiency is reduced, reduction in the random access speed to the NAND flash memory 18 may be prevented.

The end of a compressed cluster arranged at the end of a packing unit at the end of a physical page in the NAND flash memory 18 sometimes does not fit in the packing unit.

If one compressed cluster is arranged across a plurality of physical pages, two physical pages have to be read out from the cell array to read out the compressed cluster. Accordingly, the readout speed at the time of random access to the NAND flash memory 18 may be reduced.

Accordingly, in such a case, the packing processor 24B may arrange the compressed cluster not in the packing unit, but in a packing unit on the next physical page. By performing a packing process on a compressed cluster in such a manner, although the packing efficiency is reduced, reduction in the random access speed to the NAND flash memory 18 may be prevented.

Additionally, the header information included in a packing unit may further include at least one of length information indicating the length (data length) of a compressed cluster included in the packing unit and the number of compressed clusters, the beginnings of which are included in the packing unit.

Specifically, the header information included in a packing unit includes the number of compressed clusters, the beginnings of which are included in the packing unit. Furthermore, the header information is information associating, for each of compressed clusters, the beginnings of which are included in the packing unit, the LCA (logical address), the offset (position information of the compressed cluster in the packing unit), and the length information of the compressed cluster.

The size of a compressed cluster is different depending on the cluster before compression or the compression method. Accordingly, by including the length information of a compressed cluster in the header information, the compressed cluster may be extracted, at the time of reading of the compressed cluster, by the length according to the length information. Therefore, at the time of reading of data, compressed data may be easily extracted from data read out from the NAND flash memory 18.

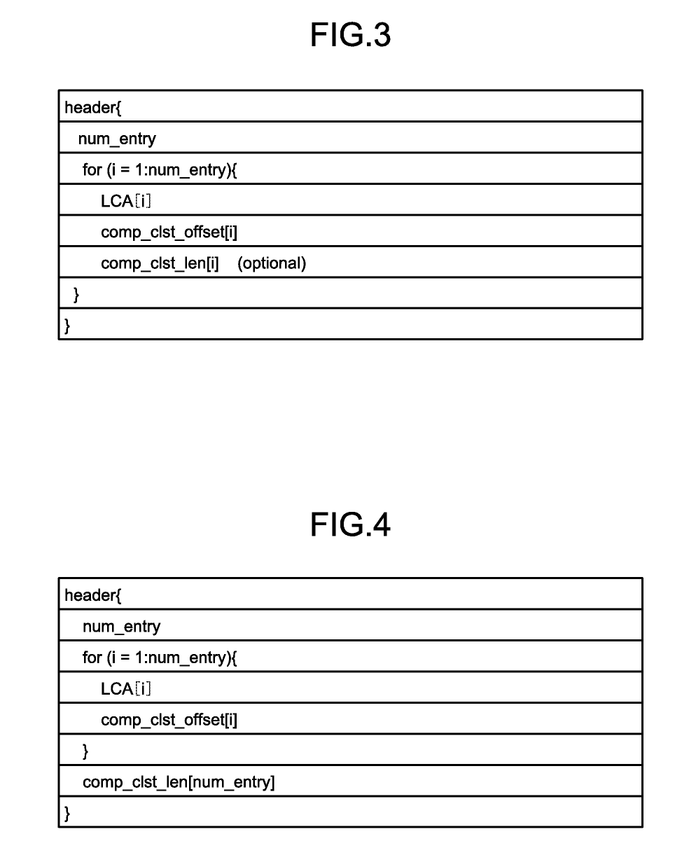

FIGS. 3 to 5 are schematic diagrams illustrating an example of data structures of header information.

For example, as illustrated in FIG. 3, the header information includes the number of compressed clusters (num_entry). Also, the header information includes, for each of the compressed clusters included in the packing unit including the header information, the LCA (logical address), the offset (position information: comp_clst_offset[i]), and the length information of the compressed cluster (comp_clst_len[i]).

Moreover, the header information may have the data structure as illustrated in FIG. 4. As illustrated in FIG. 4, the header information may include, instead of the length information of a compressed cluster (comp_clst_len[i]) in the header information illustrated in FIG. 3, the length information of a compressed cluster arranged at the end of the packing unit (comp_clst_len[num_entry]).

Furthermore, the header information may include, instead of the length information of the compressed cluster arranged at the end of the packing unit (comp_clst_len[num_entry]), position information indicating the position of the end of the compressed cluster arranged at the end of the packing unit.

The position of the end of compression data included in a packing unit coincides with the position of the beginning of a compressed cluster that is arranged next. The length of compression data that is included in a packing unit may be calculated from the positions of the end and the beginning. Therefore, according to the header information having the data structure as illustrated in FIG. 4, the position and length information of each compressed cluster included in the packing unit may be efficiently held as the header information.

Additionally, the information, included in the header information, indicating the number of compressed clusters (num_entry) may be coded by an integer of a predetermined number of bits, or may be coded by an arbitrary variable length code (such as a unary code). The predetermined number of bits may be set based on the maximum value of compressed clusters assigned to a packing unit. Also, in the case of performing coding by using a variable length code, a truncated code (such as a truncated unary code) which is capable of expressing an integer up to the maximum value of assignment to a packing unit may be used.

Furthermore, the position information (offset) and the length information may be indicated by the number of bytes. The position information (offset) of a compressed cluster may be expressed by the number of bytes from the beginning of a packing unit including the compressed cluster to the beginning position of the compressed cluster, for example. Also, the position information (offset) of a compressed cluster may be the number of bytes from the end of a packing unit including the compressed cluster to the beginning position of the compressed cluster, for example.

Furthermore, as described above, the packing processor 24B may packs a compressed cluster in units of a predetermined size (such as 8 bytes or 512 bytes), instead of in units of bytes. In such a case, the packing processor 24B may register, in the header information, as the position information (offset) of a compressed cluster or the length information of a compressed cluster, only a high order bit portion corresponding to the predetermined size.

For example, it is assumed that the predetermined size is in units of 512 bytes. 512 bytes is equal to =2⁹ bytes. In this case, the packing processor 24B may register, in the header information, as the position information (offset), a portion excluding the lower 9 bits of the position information (offset) indicated by the number of bytes. The amount of data of the header information may thereby be reduced even if the unit of packing is great.

Additionally, the data structures of the header information described above are only examples, and changes and rearrangements may be made within a similar range.

Furthermore, as described above, the data size is sometimes not reduced or is increased even when the compression process is performed by the compression section 24A. In such a case, the packing processor 24B receives, from the compression section 24A, the original cluster and a flag indicating non-compression, instead of the compressed cluster.

In the case where a flag indicating non-compression is received, the packing processor 24B may arrange the cluster received together with the flag at the beginning of the next packing unit.

For example, the size of a packing unit may be equal to the size of a (non-compressed) cluster. In such a case, the packing processor 24B may arrange the cluster in a single packing unit.

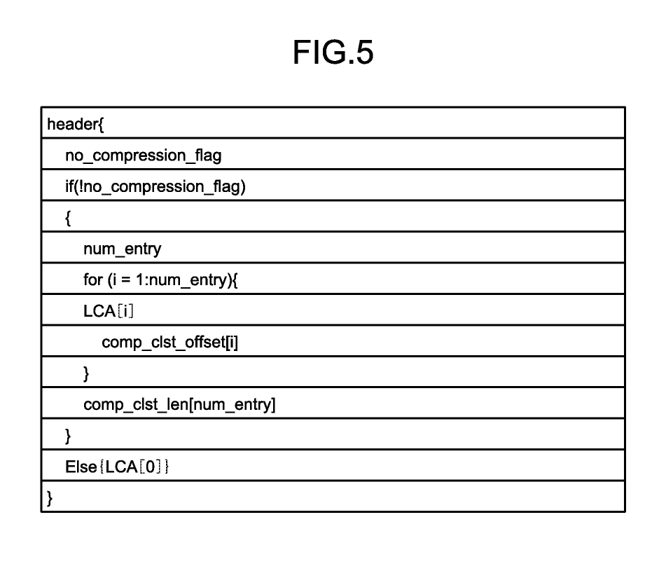

In such a case, the packing processor 24B may generate the header information as illustrated in FIG. 5. For example, if “no_compression_flag” in FIG. 5 is true, the packing processor 24B stores a non-compressed cluster in a data portion of the packing unit.

Additionally, even if there is a free region in a packing unit being generated, if the flag is received, the packing processor 24B may assign a non-compressed cluster received together with the flag to the next packing unit.

In such a case, the free region may be kept as it is by the packing processor 24B for the packing unit with the free region, immediately preceding the aforementioned packing unit, or if another compressed cluster that can fit in the free region is newly acquired, such compressed cluster may be arranged in the packing unit.

Next, a description will be given on the write section 24C. The write section 24C writes a packing unit received from the packing processor 24B into the NAND flash memory 18. Also, the write section 24C updates management information.

The write section 24C receives a packing unit from the packing processor 24B. The write section 24C accumulates at one or more packing units amounting to a physical page. When packing unit(s) amounting to a physical page is/are accumulated, the write section 24C writes the physical page into the NAND flash memory 18.

Specifically, the write section 24C transmits a write command for the physical page to the NAND flash memory 18 via the memory interface section 16. The NAND flash memory 18 then writes the received physical page into the cell array of the NAND flash memory 18.

Also, the write section 24C updates a lookup table (LUT) 18A by using a physical address, in the NAND flash memory 18, where the packing unit is written.

The LUT 18A is an example of management information. The LUT 18A associates a logical address (LCA) of a compressed cluster, and a physical address, in the NAND flash memory 18, of a packing unit including the compressed cluster (hereinafter referred to also as “unit address”).

Additionally, an additional write process cannot be performed on the NAND flash memory 18. Accordingly, instead of performing writing directly on the cell corresponding to the logical address of a compressed cluster, the write section 24C performs writing at a position where writing can be performed at a write timing. Then, the write section 24C updates the management information (LUT 18A) indicating a correspondence between the logical address (LCA) of the compressed cluster and the unit address, which is the write position in the NAND flash memory 18.

The LUT 18A is stored in a part of a region in the NAND flash memory 18. Moreover, in the present embodiment, as the write position, in the NAND flash memory 18, corresponding to the logical address of a compressed cluster, the physical address (unit address) of the packing unit including the compressed cluster is stored in the LUT 18A.

The write section 24C updates, in the LUT 18A, the unit address corresponding to the logical address (LCA) of each compressed cluster included in a packing unit written into the NAND flash memory 18 to the latest physical address (unit address) of the packing unit including the compressed cluster.

A packing unit of a compressed cluster which is obtained by compressing write target data received from the host device 12 is stored in the NAND flash memory 18 by the above-described write control by the write controller 24. Then, the LUT 18A is updated by the write controller 24.

In the case of storing a cluster in the NAND flash memory 18 without compression, the cluster size is fixed. Accordingly, in such a case, a physical address managed by the LUT 18A is an address that allows reference to the position according to the fixed cluster size.

However, the storage device 10 according to the present embodiment stores a compressed cluster in the NAND flash memory 18. The compression rate of a cluster is different depending on the cluster, the compression method or the like. Accordingly, the position (the beginning of the position) of a compressed cluster in the NAND flash memory 18 is irregular. Therefore, compared to a case of storing a non-compressed cluster in the NAND flash memory 18, the position information of a compressed cluster has to be more detailed.

As described above, with the storage device 10 of the present embodiment, the physical address (unit address), in the NAND flash memory 18, of a packing unit including a compressed cluster is managed in association with a logical address of the compressed cluster. Moreover, the logical address of the compressed cluster and position information (hereinafter referred to also as “offset”) indicating the position of the compressed cluster in the packing unit are associated with each other and stored in the header information of the packing unit.

Accordingly, an increase in the data size of the LUT 18A and an increase in the amount of data to be rewritten in the LUT 18A may be suppressed. Wearing of the NAND flash memory 18 may thus be suppressed.

Next, a description will be given on the readout controller 22. The readout controller 22 is an example of a readout controller and a readout control device.

The readout controller 22 reads out, from the NAND flash memory 18, a compressed cluster corresponding to the logical address (LBA) of readout target data, received from the host device 12, decompress the compressed cluster, and outputs the result to the host device 12.

The readout controller 22 includes the translation section 22A, the readout section 22B, the analysis section 22C, and the decompression section 22D.

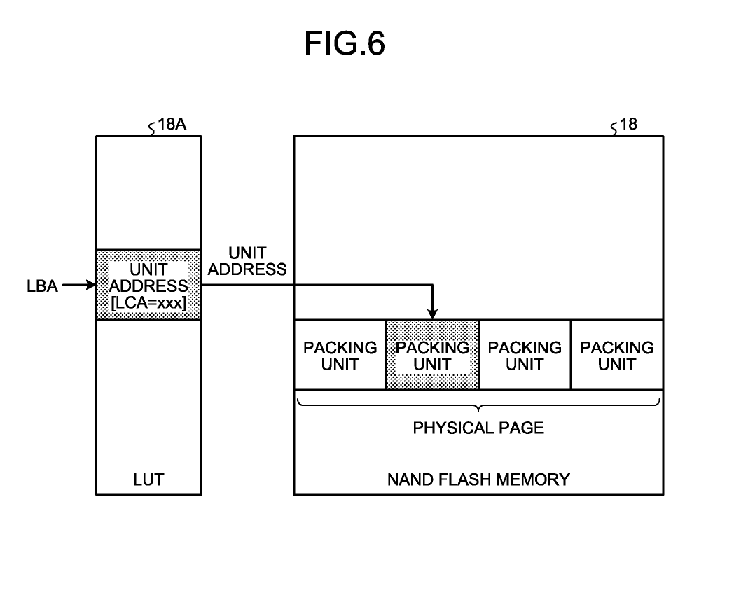

FIG. 6 is a schematic explanatory diagram for readout control.

The translation section 22A receives a readout request from the host device 12. The readout request includes a logical address (LBA) of a readout target compressed cluster. The translation section 22A translates the received logical address (LBA) into a physical address in the NAND flash memory 18.

The translation section 22A converts the logical address (LBA) into the physical address by using the LUT 18A.

As described above, the LUT 18A stores a physical address (unit address) of a packing unit including a compressed cluster, corresponding to a logical address (LCA) of the compressed cluster. Accordingly, the translation section 22A reads out the LUT 18A from the NAND flash memory 18. Then, the translation section 22A specifies, from the LUT 18A, the unit address (physical address of the packing unit) corresponding to the LCA, which is a high order bit portion of the LBA acquired from the host device 12. The translation section 22A thereby converts the received logical address (LBA) into a physical address (unit address) in the NAND flash memory 18.

The translation section 22A outputs the logical address (LCA) of the compressed cluster and the physical address (unit address) after conversion to the readout section 22B.

The readout section 22B reads out data included in the packing unit at a position, in the NAND flash memory 18, indicated by the physical address (unit address) received from the translation section 22A.

A description will be given further by referring back to FIG. 1. The analysis section 22C analyzes the header information among pieces of data included in the packing unit read out by the readout section 22B. Then, the analysis section 22C acquires position information (offset) of the readout target compressed cluster in the packing unit.

Then, the readout section 22B outputs, to the decompression section 22D, the compressed cluster at the position, in the packing unit, indicated by the position information acquired by the analysis section 22C as the readout target compressed cluster.

In the present embodiment, the analysis section 22C performs analysis of the header information in parallel to reading of data included in the packing unit by the readout section 22B.

Moreover, in the case where the position information acquired by the analysis section 22C is determined to satisfy a first condition, the readout section 22B continues reading of data until reading of at least the compressed cluster at the position indicated by the position information from the packing unit is completed. On the other hand, in the case where the position information acquired by the analysis section 22C is determined to satisfy a second condition, the readout section 22B changes the readout position to the position, in the packing unit, indicated by the position information, and reads out the compressed cluster from the readout position.

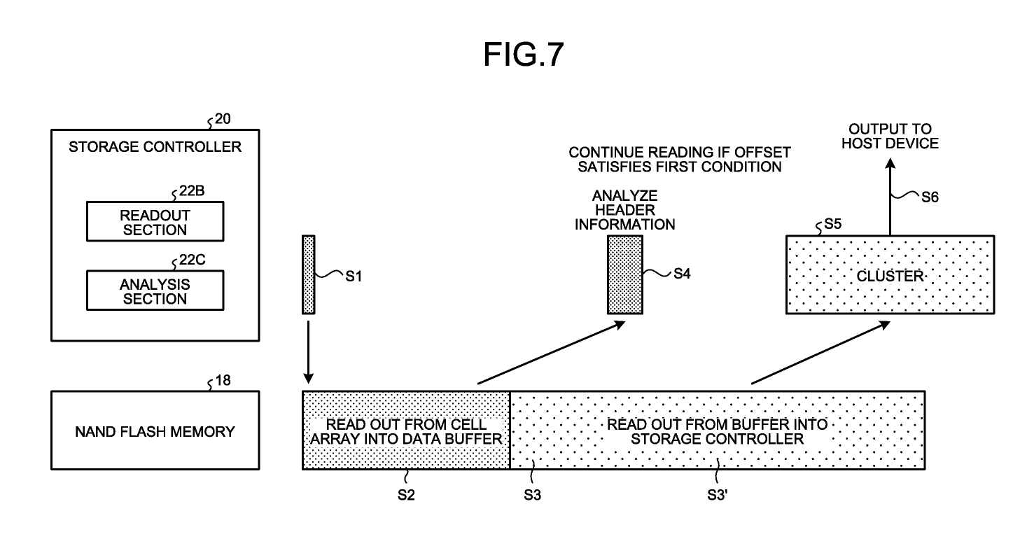

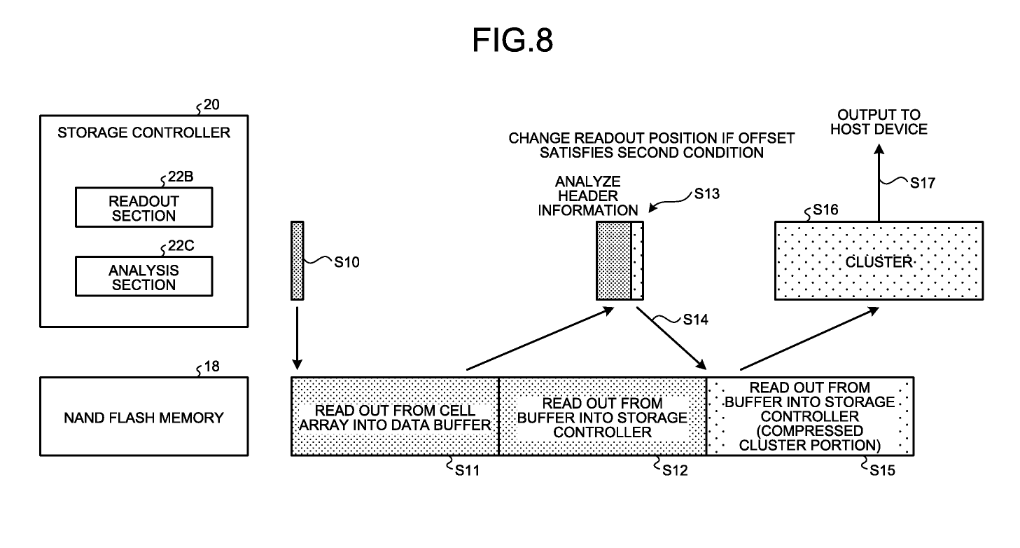

Processes by the readout section 22B and the analysis section 22C will be described with reference to FIGS. 7 and 8.

FIG. 7 is an explanatory diagram for reading of data by the readout section 22B, and analysis by the analysis section 22C. FIG. 7 illustrates a case where position information acquired by the analysis section 22C satisfies the first condition.

The first condition is that a position indicated by position information (offset) acquired by the analysis section 22C is at a position which is adjacent to header information. Also, the first condition is that a position indicated by position information (offset) acquired by the analysis section 22C is at a position which is not adjacent to header information, and that a space from the end of the header information to the position indicated by the position information is at or below a threshold.

For example, the readout section 22B issues a readout command to the NAND flash memory 18 (step S1). The readout command includes a logical address (LCA) of a compressed cluster, in the NAND flash memory 18, received from the translation section 22A, a physical address (unit address) after conversion, and a readout signal.

The NAND flash memory 18, which has received the readout command, reads out a physical page including a packing unit at the unit address included in the readout command, from the cell array to the data buffer (step S2). Then, the NAND flash memory 18 starts sequential output, to the readout section 22B, of data of the packing unit, at the unit address included in the readout command, included in the physical page read out to the data buffer (step S3). That is, in step S3, the readout section 22B sequentially reads out data of the packing unit.

The readout section 22B outputs, to the analysis section 22C, data of the packing unit sequentially output from the NAND flash memory 18, and the logical address (LCA) of the compressed cluster received from the translation section 22A.

The analysis section 22C analyzes the header information of the data read out by the readout section 22B (step S4), in parallel to the reading of the data of the packing unit by the readout section 22B (step S3). Specifically, the analysis section 22C reads, from the header information received from the readout section 22B, the position information (offset), of a compressed cluster corresponding to the logical address (LCA) received from the readout section 22B. At this time, the analysis section 22C may also read out, from the header information, other pieces of information (such as the data length of the compressed cluster) corresponding to the logical address (LCA).

Then, the readout section 22B receives the position information (offset) of the readout target compressed cluster from the analysis section 22C. Additionally, the readout section 22B may continue reading the data of the packing unit at least until the position information of the readout target compressed cluster is received from the analysis section 22C.

Then, the readout section 22B is assumed to determine that the position information received from the analysis section 22C satisfies the first condition. In such a case, reading of data from the packing unit is continued at least until reading of the compressed cluster at the position indicated by the position information is completed (step S3′).

Accordingly, in the case where the position, indicated by the position information (offset), of the readout target compressed cluster in the packing unit is a position adjacent to the header information of the packing unit, the readout section 22B continues to read out data. Also, in the case where the position, indicated by the position information (offset), of the readout target compressed cluster in the packing unit is a position which is not adjacent to the header information, and the space from the end of the header information to the position indicated by the position information is at or below the threshold, the readout section 22B continues to read out data. This threshold is the same threshold as the threshold used for the second condition described below.

Furthermore, after reading out the compressed cluster at the position indicated by the position information acquired from the analysis section 22C, the readout section 22B outputs the compressed cluster which has been read out to the decompression section 22D (step S5). The decompression section 22D outputs data obtained by expanding the compressed cluster to the host device 12 (step S6).

Next, a case where the second condition is satisfied will be described. FIG. 8 is an explanatory diagram for reading of data by the readout section 22B and analysis by the analysis section 22C. A case where position information acquired by the analysis section 22C satisfies the second condition is illustrated in FIG. 8.

The second condition is that a position indicated by position information (offset) acquired by the analysis section 22C is a position which is not adjacent to header information, and that a space from the end of the header information to the position indicated by the position information exceeds the threshold.

A value that is determined in advance may be used as the threshold. Specifically, as the threshold used for the first condition and the second condition, the amount of data that is read out by the readout section 22B during a total time of the time required by the analysis section 22C to analyze header information (for example, an average time) and the time required by the readout section 22B to change the readout position may be used.

The readout section 22B issues a readout command to the NAND flash memory 18 (step S10). The readout command includes a logical address (LCA) of a compressed cluster, in the NAND flash memory 18, received from the translation section 22A, a physical address (unit address) after conversion, and a readout signal.

The NAND flash memory 18, which has received the readout command, reads out a physical page including a packing unit at the unit address included in the readout command, from the cell array to the data buffer (step S11). Then, the NAND flash memory 18 starts sequential output, to the readout section 22B, of data of the packing unit, at the unit address included in the readout command, included in the physical page read out to the data buffer (step S12). That is, in step S12, the readout section 22B sequentially reads out data of the packing unit.

The readout section 22B outputs, to the analysis section 22C, data of the packing unit sequentially output from the NAND flash memory 18, and the logical address (LCA) of the compressed cluster received from the translation section 22A.

The analysis section 22C analyzes the header information of the data read out by the readout section 22B (step S13), in parallel to the reading of the data of the packing unit by the readout section 22B (step S12). Specifically, the analysis section 22C reads, from the header information received from the readout section 22B, the position information (offset), of a compressed cluster, corresponding to the logical address (LCA) received from the readout section 22B. At this time, the analysis section 22C may also read out, from the header information, other pieces of information (such as the data length of the compressed cluster) corresponding to the logical address (LCA).

Then, the readout section 22B receives the position information (offset) of the readout target compressed cluster from the analysis section 22C. Additionally, the readout section 22B may continue reading the data of the packing unit at least until the position information of the readout target compressed cluster is received from the analysis section 22C.

Then, in the case where the position information received from the analysis section 22C is determined to satisfy the second condition, the readout section 22B changes the readout position to the position, in the packing unit, indicated by the position information (step S14), and reads out a compressed cluster from the readout position (step S15).

Then, the readout section 22B outputs the compressed cluster which has been read out to the decompression section 22D (step S16). The decompression section 22D expands the compressed cluster, and outputs the result to the host device 12 (step S17).

Additionally, the operations illustrated in FIGS. 7 and 8 are performed by the storage controller 20 issuing various commands to the NAND flash memory 18. Specific commands are dependent on the specifications of the NAND flash memory 18 that is used. For example, in the case of using a NAND flash memory 18 according to JEDEC standard No. 230B, Page Read command (00h-30h) may be used to read out data from the cell array to the data buffer and to read out data from the buffer to the storage controller 20. Also, to change the readout position, Change Read Column command (05h-E0h) may be used. In the case of using a NAND flash memory 18 of another specification, commands of the same or similar functions as the commands mentioned above may be issued from the storage controller 20 to the NAND flash memory 18 to realize the operations described above.

Additionally, as described above, the header information of a packing unit may include length information of a compressed cluster. In such a case, the readout section 22B may end reading of data from the NAND flash memory 18 when reading has been performed from the position according to the position information (offset), of a readout target compressed cluster, acquired from the analysis section 22C to the position according to the length information (that is, the end) of the compressed cluster.

The header information of a packing unit may not include length information of a compressed cluster. In such a case, the readout section 22B may end reading at an earlier timing between reading up to a predetermined worst code amount and completion of an expansion process of a compressed cluster by the decompression section 22D.

The worst code amount is the code amount of the largest compressed cluster among compressed clusters compressed by the compression section 24A. The worst code amount is specified according to the compression method used by the compression section 24A. Additionally, as described above, in the case where the compression rate is below the threshold, the compression section 24A may output the original cluster and a flag indicating non-compression, instead of a compressed cluster. In such a case, the worst code amount may be the size of such a cluster (or the size of the cluster+the number of bits of the flag).

Furthermore, a readout target compressed cluster may be arranged across two packing units. In such a case, the header information is positioned at a beginning portion of the latter packing unit. Accordingly, the readout section 22B reads out the readout target compressed cluster up to the end of the former packing unit, and outputs the beginning portion of the next packing unit to the analysis section 22C. Also at this time, the readout section 22B continues reading of data of the packing unit in parallel to the analysis of header information by the analysis section 22C. Then, the readout section 22B removes the header information based on the header size included in the header information of the latter packing unit, and outputs the latter part of the compressed cluster to the decompression section 22D subsequently to the former part.

Next, a description will be given on the decompression section 22D. The decompression section 22D receives a compressed cluster from the readout section 22B. The decompression section 22D expands the compressed cluster, and generates a cluster (i.e., readout target data). Then, the decompression section 22D outputs the cluster to the host device 12 via the host interface section 14.

Additionally, the expansion process by the decompression section 22D may be any process as long as it is in conformity with the compression process performed by the compression section 24A. For example, it is assumed that the compression section 24A performs a compression process based on Deflate. In this case, the decompression section 22D may perform an expansion process by applying the expansion process on the compressed cluster based on Deflate.

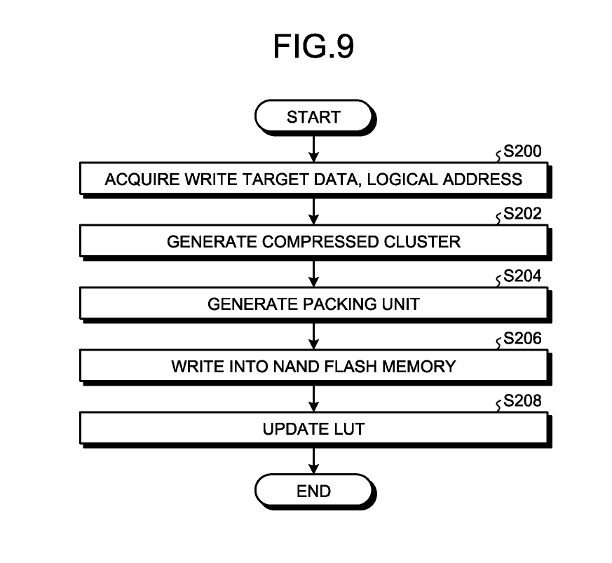

Next, an example of a procedure of a write process that is performed by the storage device 10 will be described. FIG. 9 is a flowchart illustrating an example of a procedure of a write process.

First, the write controller 24 acquires a write request including write target data (cluster) and a logical address (LBA) from the host device 12 via the host interface section 14 (step S200).

Next, the compression section 24A compresses the write target data (cluster) acquired in step S200, and generates a compressed cluster (step S202). Then, the packing processor 24B generates a packing unit including the compressed cluster generated in step S202 and header information (step S204).

Next, the write section 24C writes the packing unit generated in step S204 into the NAND flash memory 18 (step S206), and updates the LUT 18A (step S208). Then, the present routine is ended.

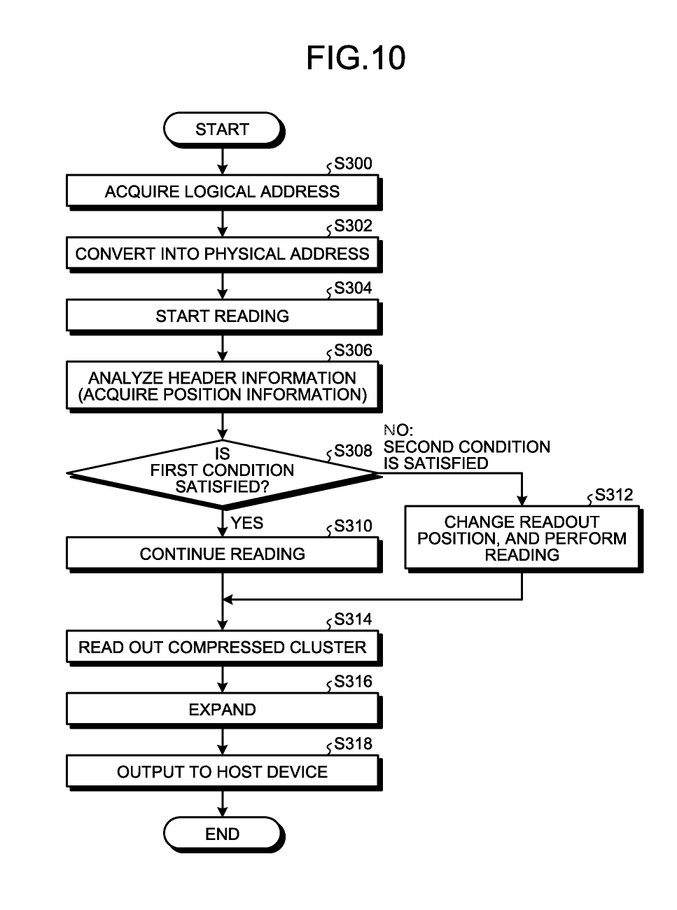

Next, an example of a procedure of a readout process that is performed by the storage device 10 will be described. FIG. 10 is a flowchart illustrating an example of a procedure of a readout process.

First, the translation section 22A acquires a logical address (LBA) of a readout target compressed cluster (step S300). Next, the translation section 22A converts the logical address (LCA, which is a high order bit portion of the LBA) acquired in step S300 into a physical address (unit address) in the NAND flash memory 18 (step S302).

Next, the readout section 22B starts reading of data of the packing unit at the position of the physical address obtained by conversion in step S302 (step S304). The analysis section 22C analyzes the header information included in the data (step S306), in parallel to the reading of the data started in step S304. The analysis section 22C acquires the position information (offset) of the readout target compressed cluster by the process in step S306. As described above, at this time, the analysis section 22C may also acquire the data length information of the compressed cluster.

Next, the readout section 22B determines whether the position information analyzed in step S306 satisfies the first condition or the second condition (step S308). In the case where it is determined that the first condition is satisfied (step S308: Yes), the process proceeds to step S310.

In step S310, the readout section 22B continues reading of the data of the packing unit (step S310), and the process proceeds to step S314.

On the other hand, in the case where it is determined in step S308 that the second condition is satisfied (step S308: No), the process proceeds to step S312. In step S312, the readout section 22B changes the readout position to the position, in the packing unit, indicated by the position information, and sequentially reads out data of the compressed cluster from the readout position (step S312). Then, the process proceeds to step S314.

When the compressed cluster at the position indicated by the position information acquired in step S306 is read out by the readout section 22B (step S314), the decompression section 22D expands the compressed cluster (step S316).

The decompression section 22D outputs the cluster obtained by the expansion process to the host device 12 via the host interface section 14 (step S318). Then, the present routine is ended.

As described above, the storage device 10 (readout controller 22) of the present embodiment includes the translation section 22A, the readout section 22B, and the analysis section 22C. The translation section 22A converts a logical address of a readout target compressed cluster into a physical address in the NAND flash memory 18 (non-volatile memory). The readout section 22B reads out, from the NAND flash memory 18, data included in the packing unit at the position indicated by the physical address. The analysis section 22C analyzes the header information included in the packing unit, in parallel to reading of the data included in the packing unit, and acquires position information of the readout target compressed cluster in the packing unit.

As described above, according to the storage device 10 of the present embodiment, analysis of header information of a packing unit is performed by the analysis section 22C in parallel to reading of data from the NAND flash memory 18 by the readout section 22B. In other words, according to the storage device 10 of the present embodiment, reading of data from the NAND flash memory 18 is continued in parallel during analysis of data read out from the NAND flash memory 18.

Accordingly, reduction in the random access performance of the readout section 22B caused by analysis of header information by the analysis section 22C may be suppressed. Also, according to the present embodiment, a compressed cluster obtained by compressing a cluster is stored in the NAND flash memory 18. Accordingly, the amount of data to be read out from the NAND flash memory 18 may be reduced, and the readout speed may be increased. That is, the storage device 10 of the present embodiment may achieve reduction in the amount of delay at the time of reading of data from the NAND flash memory 18, and also, improvement in the random readout performance.

Accordingly, the readout controller 22 (storage device 10) of the present embodiment may suppress reduction in the access speed to the non-volatile memory (NAND flash memory 18).

Furthermore, the translation section 22A of the storage device 10 of the present embodiment converts a logical address of a readout target compressed cluster into a physical address indicating the position, in the NAND flash memory 18 (non-volatile memory), of the packing unit including the compressed cluster, by using the LUT 18A (management information). Moreover, header information included in a packing unit includes position information (offset) of a compressed cluster included in the packing unit including the header information, and the logical address of the compressed cluster. Accordingly, the amount of data to be stored in the LUT 18A may be reduced.

As the size of the LUT 18A is increased, the number of entries that can be held as caches is reduced, and thus, the access speed to the NAND flash memory 18, especially, the access speed at the time of random read, is possibly reduced.

On the other hand, with the storage device 10 of the present embodiment, the aforementioned information may be stored in the LUT 18A and the header information, and thus, in addition to the effects described above, reduction in the access speed especially at the time of random read may be suppressed.

Furthermore, with the storage device 10 of the present embodiment, the data readout speed from the NAND flash memory 18 may be particularly effectively increased in a case where a compressed cluster with particularly high compression efficiency is stored in the NAND flash memory 18.

Moreover, with the storage device 10 of the present embodiment, in the case where the position information (offset) is determined to satisfy the first condition, the readout section 22B continues reading of data from the packing unit until readout of at least a compressed cluster at a position indicated by the position information is completed. On the other hand, in the case where the position information (offset) is determined to satisfy the second condition, the readout section 22B changes the readout position to the position, in the packing unit, indicated by the position information, and reads out a compressed cluster from the readout position.

Accordingly, reduction in the data readout speed from the NAND flash memory 18 may be suppressed in both a case where a readout target compressed cluster is arranged following the header information and a case where a readout target compressed cluster is arranged away from the header information. Also, with the storage device 10, a delay caused by analysis of header information may be reduced, and reduction in the data readout speed from the NAND flash memory 18 may be suppressed.

Moreover, as described above, in the present embodiment, in the case where a flag indicating non-compression is received (that is, in the case where the compression rate is below a threshold), the packing processor 24B arranges a non-compressed cluster received together with the flag at the beginning of the next packing unit. As described above, the size of a packing unit may be equal to the size of a (non-compressed) cluster. In such a case, the packing processor 24B simply arranges the cluster in a single packing unit.

In the case of performing such processing, a cluster is written into the NAND flash memory 18 in the same manner as with a conventional storage device which stores a non-compressed cluster in the NAND flash memory 18. As described above, in the present embodiment, in the case where header information and a compressed cluster are arranged adjacent to each other, reading of data included in the packing unit is performed in parallel to analysis of the header information.

Accordingly, in the present embodiment, a delay due to analysis of header information may be suppressed. Therefore, even in a case where a cluster before compression, corresponding to a compressed cluster whose compression rate is at or below a threshold, is stored in the NAND flash memory 18, a delay in the time required for readout may be suppressed compared with a conventional technology.

On the other hand, in the case where the write section 24C stores a compressed cluster in the NAND flash memory 18, the amount of data to be written into the NAND flash memory 18 and the amount of data to be read out from the NAND flash memory 18 may be reduced.

Accordingly, with the storage device 10 of the present embodiment, reduction in the access speed (write speed, readout speed) to the NAND flash memory 18 may be suppressed.

Additionally, the write controller 24 desirably arranges compressed clusters in a packing unit with no space therebetween. Also, the write controller 24 desirably arranges packing units in one physical page with no space therebetween (see FIG. 2).

By arranging compressed clusters in the above manner, even in a case of writing write target data amounting to the specified capacity of the NAND flash memory 18, for example, the number of physical pages to be actually written into the NAND flash memory 18 may be reduced. Accordingly, compared to a case of writing a cluster, instead of a compressed cluster, into the NAND flash memory 18, a surplus region that is left in the NAND flash memory 18 is increased.

A spare region is provided in the NAND flash memory 18. Accordingly, the NAND flash memory 18 actually has a storage capacity that is greater than the specified capacity.

When there is the surplus region mentioned above, the storage device 10 desirably uses the surplus region as the spare region.

For example, the spare region may be used as an alternative region for a bad block or the like, or as a region for storing information indicating an error correction code. For example, the bad block is a block for which readout, writing or erasure cannot be or can no longer be correctly performed. The reliability of the storage device 10 can be increased by using the surplus region as the spare region.

Furthermore, the storage device 10 may use the spare region to increase the efficiency of garbage collection (GC). In this case, the reliability and the life of the storage device 10 may be improved, and the processing speed of writing and the like into the NAND flash memory 18 may be increased.

GC is a process of evacuating and erasing an effective (non-updated) cluster from a written block and of newly creating a writable block when there are not enough writable physical blocks in the NAND flash memory 18 on which an additional write process cannot be performed. Effective data evacuated from a block which is the target of GC is re-written into a writable block.

Generally, the ratio between the total amount of writing in the NAND flash memory 18, including writing due to GC or the like (the total of the amount of data of write target data acquired from the host device 12 and the amount of GC data), and the amount of data of write target data acquired from the host device 12 is referred to as Write Amplification (WA). If the value of the WA is great, the total amount of writing in the NAND flash memory 18 is increased. Accordingly, the greater a WA value is, the more a write speed from the host device 12 to the NAND flash memory 18 is reduced, and the more a deterioration speed of the NAND flash memory 18 is increased due to the write stress, and the like.

As described above, with the storage device 10 of the present embodiment, compressed clusters obtained by compressing write target data in units of clusters are written into the NAND flash memory 18. Accordingly, the data size of data to be written into the NAND flash memory 18 from the host device 12 is reduced due to compression. By using a spare region, in the NAND flash memory 18, increased by compression of clusters as a writable region, an expected value of the number of pieces of effective data included in a GC target block may be reduced. The storage device 10 of the present embodiment may thus reduce the WA value. Accordingly, in addition to the effects described above, the storage device 10 may suppress deterioration of the NAND flash memory 18 and may increase the write speed.

### Second Embodiment

In a present embodiment, a case of writing, into a NAND flash memory 18, data to which an error correction code is added will be described.

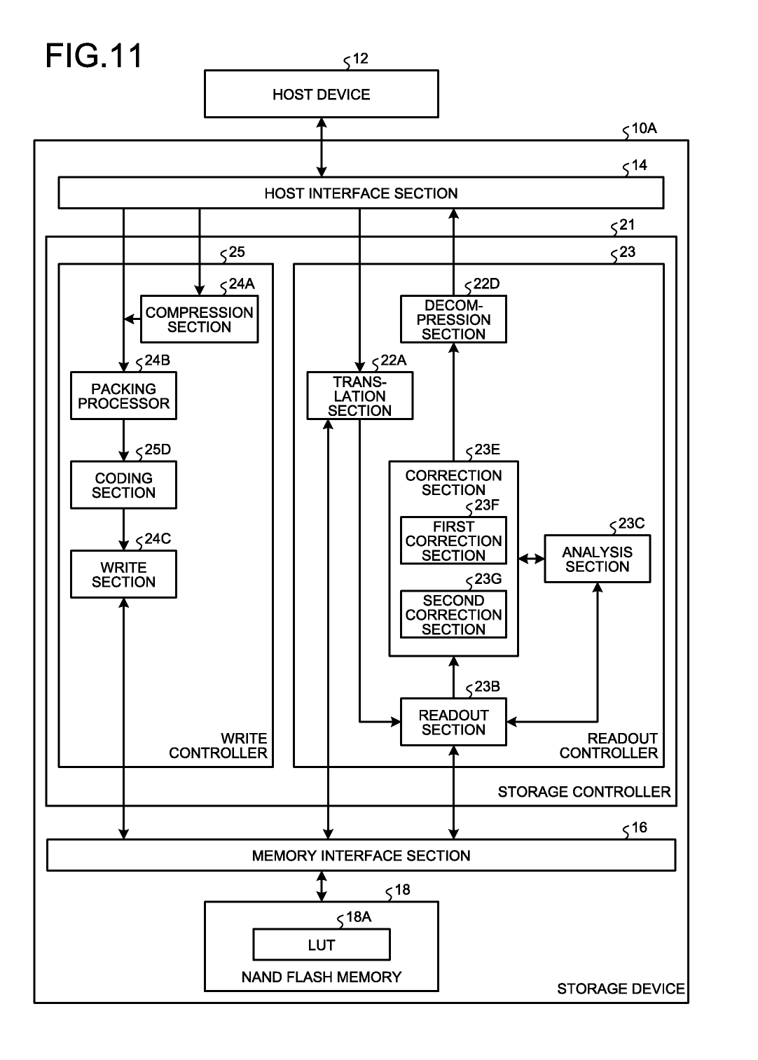

FIG. 11 is a schematic diagram illustrating an example of a storage device 10A according to the present embodiment. Additionally, in the present embodiment, structural elements having the same functions as those of the first embodiment are denoted with the same reference signs, and a detailed description thereof may be omitted.

The storage device 10A is communicatively connected to a host device 12. The host device 12 is the same as that of the first embodiment.

The storage device 10A includes a host interface section 14, a storage controller 21, a memory interface section 16, and a NAND flash memory 18. The storage device 10A is the same as the storage device 10 of the first embodiment except that the storage device 10A includes a storage controller 21 instead of the storage controller 20.

The storage controller 21 includes a write controller 25, and a readout controller 23. The write controller 25 includes a compression section 24A, a packing processor 24B, a write section 24C, and a coding section 25D. The storage controller 21 includes the write controller 25 and the readout controller 23 instead of the write controller 24 and the readout controller 22 of the first embodiment.

The write controller 25 includes the compression section 24A, the packing processor 24B, the coding section 25D, and the write section 24C. The readout controller 23 includes a translation section 22A, a readout section 23B, an analysis section 23C, a correction section 23E, and an decompression section 22D. For example, the readout controller 23, the translation section 22A, the readout section 23B, the analysis section 23C, the correction section 23E, the decompression section 22D, the write controller 25, the compression section 24A, the packing processor 24B, the coding section 25D, and the write section 24C are realized by one or a plurality of processors. For example, each of the sections mentioned above may alternatively be realized by causing a processor such as a CPU to execute a program, that is, by software. Each of the sections mentioned above may alternatively be realized by a processor such as a dedicated IC, that is, by hardware. Each of the sections mentioned above may alternatively be realized by a combination of software and hardware. In the case of using a plurality of processors, each processor may realize one of the sections, or two or more of the sections.

The processor realizes each of the sections mentioned above by reading out a program saved in a storage section and by executing the program. Additionally, instead of saving a program in the storage section, the program may be directly embedded in the circuit of the processor. In this case, the processor reads out and executes the program embedded in the circuit to realize each of the sections mentioned above.

First, a description will be given on the write controller 25. The write controller 25 includes the compression section 24A, the packing processor 24B, the coding section 25D, and the write section 24C. The compression section 24A, the packing processor 24B, and the write section 24C are the same as those of the first embodiment.

The coding section 25D receives a packing unit from the packing processor 24B. The coding section 25D calculates and adds an error correction code on a per packing unit basis or on a per sub-block of each packing units basis.

A data unit for application of an error correction code is an example of a first unit. The data unit to which an error correction code is to be added is sometimes referred to as an ECC frame. The first unit is desirably smaller than the size of a non-compressed cluster corresponding to a compressed cluster.

An error correction code is a low-density parity check (LDPC) code, a BCH code, or a Reed-Solomon code, for example.

Additionally, the first unit, which is the data unit for application of an error correction code, may be of a fixed length or a variable length.

For example, the coding section 25D may set, for a vicinity of the beginning of a packing unit, a first unit which is smaller compared to that of other than the vicinity of the beginning. The vicinity of the beginning of a packing unit is a part corresponding to the maximum size of header information included in the packing unit, for example.

By the coding section 25D adding an error correction code in the vicinity of the beginning of a packing unit in a smaller first unit compared to other than the vicinity of the beginning, the amount of data read out from the packing unit, by the readout controller 23, for analysis of header information may be reduced.

Additionally, in this case, the coding section 25D desirably performs a process of increasing the proportion of the number of bits of the error correction code (for example, parity bits) to be added in the vicinity of the beginning of a packing unit than for other than the beginning, for example. By performing the process, the error correction performance of an error correction code added to the part of a smaller first unit may be prevented from being reduced compared to a region of a greater first unit. Additionally, to increase the number of parity bits, the coding section 25D may use a part which was originally used for another first unit, for example.

Moreover, the coding section 25D may independently add an error detection code or an error correction code to a part of header information in a packing unit (such as a part corresponding to the maximum size of header information).

The readout controller 23 may thus read out only the part of header information in a packing unit, and may perform error detection, error correction, or analysis of the header information. Accordingly, the storage device 10A may reduce a delay in the analysis of header information.

Additionally, as described in the first embodiment, header information includes types of data including the number of compressed clusters, the beginnings of which are included in a packing unit, the length of a compressed cluster (data length), position information (offset) of a compressed cluster, the logical address (LCA) of a compressed cluster, and the like (see FIGS. 3 to 5).

The coding section 25D may add an error detection code or an error correction code (such as a parity check code) to each type of data, for example.

If an error detection code or an error correction code is added to each of types of data included in the header information, the readout controller 23 may perform error detection or error correction, and analysis for each of types of data.

Additionally, an error correction code may be added to each of the part of the header information and a first unit which includes the entire header information and which is of a longer data length than the header information.

As described above, by adding an error correction code to each of first units of a packing unit whose sizes are increased stepwise, even if error correction cannot be performed by the error correction code added to a first unit with the smallest size, error correction may be performed by an error correction code added to a first unit of a greater size.

For example, in the case where error correction cannot be performed by using an error correction code added to the header information, error correction may be performed by using an error correction code added to a first unit of a greater size than the header information so as to restore the header information.

Moreover, the first unit used by the coding section 25D may be fixed, and the packing processor 24B may perform packing of compressed clusters for each of first units used by the coding section 25D to thereby generate a packing unit. That is, the packing unit generated by the packing processor 24B and the first unit to which an error correction code is to be added by the coding section 25D may be made the same.

For example, a compressed cluster with a shorter data length than the first unit may be arranged across two first units (ECC frames). In such a case, the readout controller 23 has to read out at least two ECC frames to read out the compressed cluster. Accordingly, the packing processor 24B packs a compressed cluster on a per first unit basis, as described above. The readout controller 23 may thereby reduce the process of reading out a plurality of ECC frames in order to read out a readout target compressed cluster, and the readout speed may be increased.

Additionally, in the case of packing compressed clusters on a per first unit basis, the packing efficiency is more reduced as the data size of the first unit is increased. Accordingly, the packing processor 24B packs a compressed cluster on a per first unit basis in a case where the compression rate of the compressed cluster is at or above a threshold (for example, 90%). Moreover, if the compression rate of a compressed cluster is below a threshold (for example, 50%), the packing processor 24B may pack the compressed cluster on a predetermined unit basis even in a case where the compressed cluster is arranged across two packing units.

The coding section 25D outputs a packing unit to which an error correction code is added to the write section 24C. The write section 24C performs writing of the packing unit into the NAND flash memory 18 and update of a LUT 18A, in the same manner as in the first embodiment.

Next, a description will be given on the readout controller 23.

The readout controller 23 includes the translation section 22A, the readout section 23B, the analysis section 23C, the correction section 23E, and the decompression section 22D. The translation section 22A and the decompression section 22D are the same as those of the first embodiment.

Like the readout section 22B of the first embodiment, the readout section 23B sequentially reads out data included in a packing unit at the position, in the NAND flash memory 18, indicated by a physical address (unit address) received from the translation section 22A. Then, the readout section 23B sequentially outputs the data which has been read out to the correction section 23E.

The correction section 23E performs error correction by using an error correction code, added on a per first unit basis, in the data read out by the readout section 23B.

The correction section 23E performs error correction by using a correction method according to the error correction code added by the coding section 25D.

Then, the correction section 23E outputs data after error correction to the analysis section 23C.

Like the analysis section 22C of the first embodiment, the analysis section 23C analyzes the header information among pieces of data included in the packing unit read out by the readout section 23B. That is, the analysis section 23C analyzes the header information on which error correction has been performed by the correction section 23E. Then, like the analysis section 22C of the first embodiment, the analysis section 23C acquires the position information (offset), in the packing unit, of a readout target compressed cluster, and outputs the position information to the readout section 23B.

Then, the readout section 23B outputs, to the correction section 23E, as the readout target compressed cluster, a compressed cluster at the position, in the packing unit, indicated by the position information acquired by the analysis section 23C. The correction section 23E performs error correction on the compressed cluster acquired from the readout section 23B, and outputs the result to the decompression section 22D. As in the first embodiment, the decompression section 22D expands the compressed cluster, and outputs the result to the host device 12 via the host interface section 14.

Here, as in the first embodiment, the analysis section 23C performs analysis of the header information in parallel to the reading, by the readout section 23B, of data included in the packing unit.

Then, in the case where it is determined that the position information acquired by the analysis section 23C satisfies a first condition, the readout section 23B continues reading of the data. On the other hand, in the case where it is determined that the position information acquired by the analysis section 23C satisfies a second condition, the readout section 23B changes the readout position to the position, in the packing unit, indicated by the position information, and reads out a compressed cluster from the readout position. The first and the second conditions are the same as those of the first embodiment.

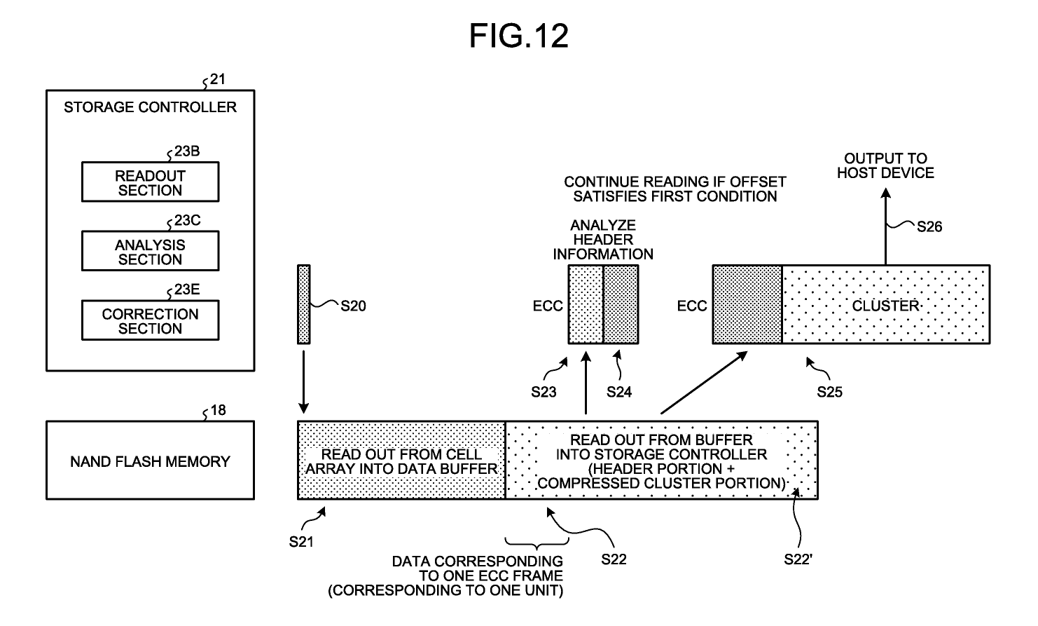

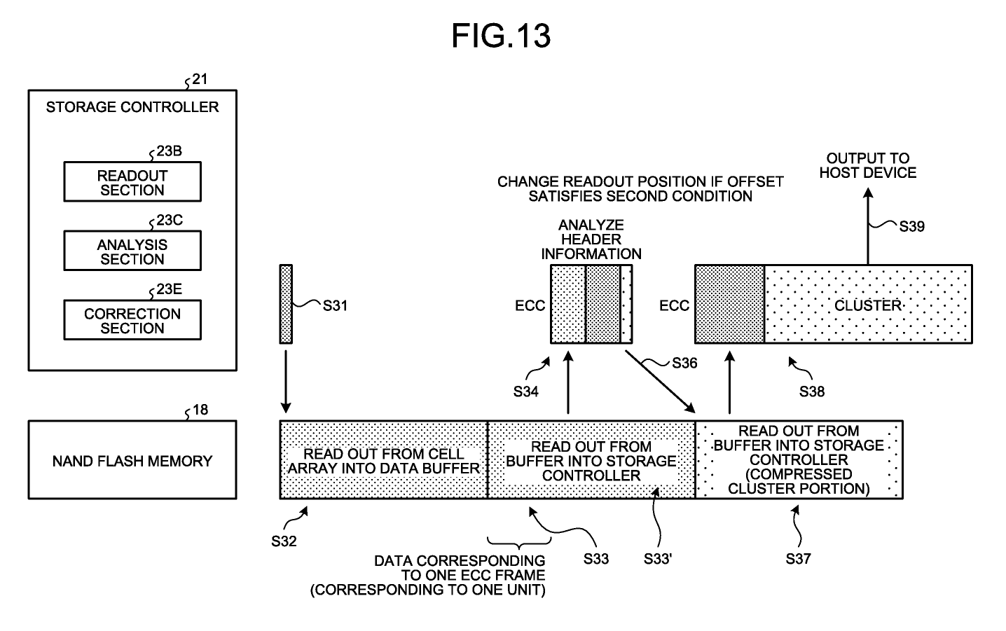

Processes by the readout section 23B and the analysis section 23C will be described with reference to FIGS. 12 and 13.

FIG. 12 is an explanatory diagram for readout of data by the readout section 23B and analysis by the analysis section 23C. FIG. 12 illustrates a case where position information acquired by the analysis section 23C satisfies the first condition.

For example, the readout section 23B issues a readout command to the NAND flash memory 18 (step S20). The readout command includes a logical address (LCA) of a compressed cluster, in the NAND flash memory 18, received from the translation section 22A, a physical address (unit address) after conversion, and a readout signal.

The NAND flash memory 18, which has received the readout command, reads out a physical page including a packing unit at the unit address included in the readout command, from the cell array to the data buffer (step S21). Then, the NAND flash memory 18 starts sequential output, to the readout section 23B, of data of the packing unit, at the unit address included in the readout command, included in the physical page read out to the data buffer (step S22). That is, in step S22, the readout section 23B sequentially reads out data of the packing unit.

The readout section 23B sequentially outputs, to the correction section 23E, data of the packing unit sequentially output from the NAND flash memory 18. The correction section 23E performs error correction when data corresponding to the first unit (ECC frame), which is a unit to which an error correction code is added, is received (step S23).

The analysis section 23C analyzes header information on which error correction has been performed by the correction section 23E (step S24), in parallel to reading of data of the packing unit by the readout section 23B (step S22, step S22′). The analysis section 23C outputs, by this analysis, position information of a readout target compressed cluster to the readout section 23B. Additionally, the analysis section 23C receives the logical address (LCA) of the compressed cluster from the readout section 23B before the analysis, and uses the logical address to specify the position information.

Additionally, the data size of header information is smaller than the size of a compressed cluster. Moreover, in many cases, the header information fits in the first unit, which is a unit to which an error correction code is added. Accordingly, when the readout section 23B reads out data corresponding to the first one unit of the packing unit (step S22), and the correction section 23E performs error correction (step S23), the analysis section 23C is enabled to analyze the header information (step S24).

Additionally, as the size of header information, the maximum number of compressed clusters that can be included in a packing unit is desirably set. The maximum size of header information may be specified by this setting.

Then, the readout section 23B is assumed to determine that the position information received from the analysis section 23C satisfies the first condition. In this case, the readout controller 23 continues reading of data (step S22′).

Accordingly, in the case where the position of the readout target compressed cluster, in the packing unit, indicated by the position information (offset) is a position adjacent to the header information of the packing unit, the readout section 23B continues reading of data. Also, in the case where the position of the readout target compressed cluster, in the packing unit, indicated by the position information (offset) is a position which is not adjacent to the header information, and the space from the end of the header information to the position indicated by the position information is at or below a threshold, the readout section 23B continues reading of data. A value determined in advance may be used as the threshold.

Then, after reading out a first unit (ECC frame) including the compressed cluster at the position indicated by the position information acquired from the analysis section 23C, the readout section 23B outputs the first unit which has been read out to the correction section 23E. The correction section 23E performs error correction, and outputs the compressed cluster after error correction to the decompression section 22D (step S25). The decompression section 22D expands the compressed cluster, and outputs the result to the host device 12 (step S26).

Next, a description will be given on a case where the second condition is satisfied. FIG. 13 is an explanatory diagram for readout of data by the readout section 23B and analysis by the analysis section 23C. FIG. 13 illustrates a case where position information acquired by the analysis section 23C satisfies the second condition.

The readout section 23B issues a readout command to the NAND flash memory 18 (step S31). The readout command includes a logical address (LCA) of a compressed cluster, in the NAND flash memory 18, received from the translation section 22A, a physical address (unit address) after conversion, and a readout signal.

The NAND flash memory 18, which has received the readout command, reads out a physical page including a packing unit at the unit address included in the readout command, from the cell array to the data buffer (step S32). Then, the NAND flash memory 18 starts sequential output, to the readout section 23B, of data of the packing unit, at the unit address included in the readout command, included in the physical page read out to the data buffer (steps S33, S33′). That is, in steps S33, S33′, the readout section 23B sequentially reads out data of the packing unit.

The readout section 23B sequentially outputs, to the correction section 23E, data of the packing unit sequentially output from the NAND flash memory 18. The correction section 23E performs error correction when data corresponding to the first unit (ECC frame), which is a unit to which an error correction code is added, is received (step S34).

Then, the readout section 23B is assumed to determine that the position information received from the analysis section 23C satisfies the second condition. In this case, the readout section 23B changes the readout position to the beginning position of the first unit (ECC frame) including the position, in the packing unit, indicated by the position information (step S36). That is, the readout section 23B changes the readout position to the beginning position of the first unit (ECC frame) including the beginning of the compressed cluster stored at the position indicated by the position information. Then, the readout section 23B reads out the compressed cluster from the readout position after change (step S37).

Then, after reading out the first unit (ECC frame) including the compressed cluster at the position indicated by the position information acquired from the analysis section 23C, the readout section 23B outputs the first unit which has been read out to the correction section 23E. The correction section 23E performs error correction, and outputs the compressed cluster after error correction to the decompression section 22D (step S38). The decompression section 22D expands the compressed cluster, and outputs the result to the host device 12 (step S39).

Additionally, as described above, the coding section 25D may independently add an error correction code to the part of header information in a packing unit, and also, adds an error correction code to each first unit of a data size greater than that of the header information.

In such a case, the coding section 25D desirably includes a first correction section 23F and a second correction section 23G.

The first correction section 23F performs error correction on header information by using an error correction code, added to the header information, in data read out by the readout section 23B. The second correction section 23G performs error correction by using an error correction code added to each first unit of a data size greater than that of the header information.

Then, in the case of success of error correction on the header information by the first correction section 23F, the analysis section 23C analyzes the header information on which error correction has been performed by the first correction section 23F. Also, in the case of failure of error correction on the header information by the first correction section 23F, the analysis section 23C may analyze header information included in data of a first unit on which error correction has been performed by the second correction section 23G.

As described above, according to the storage device 10A of the present embodiment, the coding section 25D adds an error correction code on a per first unit basis. Then, a packing unit to which an error correction code is added is stored in the NAND flash memory 18. Moreover, at the readout controller 23, the correction section 23E performs error correction by using the error correction code that is added.

In the NAND flash memory 18, due to a change over time in the internal state of the memory cell, noise at the time of reading, or the like, a part of readout data possibly takes a different value from the time of writing. Accordingly, in addition to the effects of the first embodiment, the storage device 10A can perform error correction on data stored in the NAND flash memory 18 by using the coding section 25D and the correction section 23E.

Furthermore, as in the first embodiment, according to the storage device 10A of the present embodiment, the readout speed may be increased by use of compressed clusters, and also, the life of the NAND flash memory 18 may be increased.

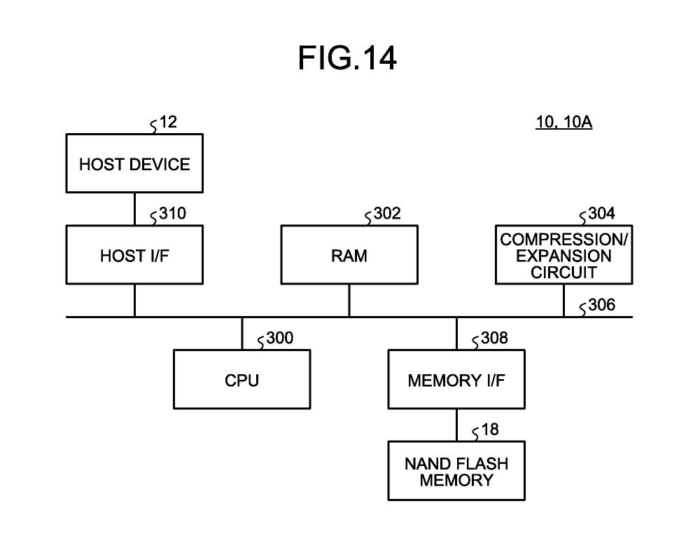

Next, an example of the hardware configuration of the storage devices 10, 10A of the embodiments described above will be described. FIG. 14 is an example hardware configuration diagram for the storage devices 10, 10A of the embodiments described above.

The storage devices 10, 10A of the embodiments described above include a control device such as a CPU 300, a storage device such as a random access memory (RAM) 302, a compression/expansion circuit 304, a memory I/F 308, a host I/F 310, and a bus 306 connecting each section.

The host I/F 310 corresponds to the host interface section 14 described above. The host I/F 310 is connected to the host device 12. The memory I/F 308 corresponds to the memory interface section 16 described above. The memory I/F 308 is connected to the NAND flash memory 18. The compression/expansion circuit 304 corresponds to the compression section 24A and the decompression section 22D described above.

The RAM 302 is a volatile storage device for temporarily storing data (cluster), compressed clusters, logical addresses (LCA, LBA) and the like acquired from the host device 12 or to be transmitted to the host device 12. Additionally, the RAM 302 may be used to cache a part or all of the LUT 18A. For example, the RAM 302 is a static RAM (SRAM) or a dynamic RAM (DRAM).

With the storage devices 10, 10A of the embodiments described above, each section is realized on a computer by the CPU 300 reading out a program from a ROM onto the RAM 302 and executing the program.

Additionally, programs for performing the processes to be performed by the storage devices 10, 10A of the embodiments described above may be stored in an HDD. The programs for performing the processes to be performed by the storage devices 10, 10A of the embodiments described above may alternatively be provided by being embedded in a ROM in advance.

Moreover, the programs for performing processes to be performed by the storage devices 10, 10A of the embodiments described above may be provided as a computer program product by being stored in a computer-readable storage medium, such as a CD-ROM, a CD-R, a memory card, a digital versatile disk (DVD), or a flexible disk (FD), in the form of an installable or executable file. Moreover, the programs for performing the processes to be performed by the storage devices 10, 10A of the embodiments described above may be stored on a computer which is connected to a network such as the Internet, and be provided by being downloaded via the network. Moreover, the programs for performing the processes to be performed by the storage devices 10, 10A of the embodiments described above may be provided or distributed via a network such as the Internet.

Additionally, the hardware configuration illustrated in FIG. 14 is only an example, and the storage devices 10, 10A may be realized by other hardware configurations. For example, the CPU 300 and the compression/expansion circuit 304 may be achieved partially or wholly by a dedicated circuit, or may be achieved by a general-purpose arithmetic device (such as a CPU).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A readout control device comprising:
a memory; and
one or more processors configured to function as a converter, a reader and an analyzer, wherein
the converter converts a logical address of a compressed cluster that is a readout target into a physical address in a non-volatile memory;
the reader reads out, from the non-volatile memory, data included in a packing unit at a position indicated by the physical address; and
the analyzer analyzes header information included in the packing unit, in parallel to reading of the data included in the packing unit, and acquires position information of the compressed cluster that is the readout target in the packing unit.

2. The readout control device according to claim 1, wherein the reader outputs the compressed cluster at a position, in the packing unit, indicated by the position information as the compressed cluster that is the readout target.

3. The readout control device according to claim 1, wherein the converter converts the logical address of the compressed cluster into the physical address by using management information associating the logical address of the compressed cluster and the physical address indicating a position, in the non-volatile memory, of the packing unit including the compressed cluster.

4. The readout control device according to claim 1, wherein the reader continues, in a case where the position information is determined to satisfy a first condition, reading of data until reading, from the packing unit, of at least the compressed cluster at the position indicated by the position information is completed, and
changes, in a case where the position information is determined to satisfy a second condition, a readout position to the position, in the packing unit, indicated by the position information, and reads out the compressed cluster from the readout position.

5. The readout control device according to claim 4, wherein the reader determines that the first condition is satisfied, in a case where a position indicated by the position information acquired by the analyzer is a position adjacent to the header information or in a case where a position indicated by the position information acquired by the analyzer is a position that is not adjacent to the header information and a space from an end of the header information to the position indicated by the position information is at or below a threshold, and
determines that the second condition is satisfied, in a case where a position indicated by the position information acquired by the analyzer is a position that is not adjacent to the header information and the space exceeds the threshold.

6. The readout control device according to claim 1, comprising the one or more processors configured to further function as a corrector, wherein
the corrector performs error correction by using an error correction code, added to each first unit, in data that is read out by the reader, and
the analyzer analyzes the header information on which error correction has been performed.

7. The readout control device according to claim 6,
wherein the corrector includes
a first corrector performs error correction on the header information by using an error correction code, added to the header information, in data that is read out by the reader, and
a second corrector performs error correction by using an error correction code that is added to each first unit of a data size greater than the header information, and
wherein the analyzer analyzes, in a case of success of error correction on the header information by the first corrector, the header information on which error correction has been performed, and analyzes, in a case of failure of error correction on the header information by the first corrector, the header information included in data of the first unit on which error correction has been performed by the second corrector.

8. The readout control device according to claim 1, wherein the header information includes the position information of the compressed cluster included in the packing unit including the header information, and the logical address of the compressed cluster.

9. The readout control device according to claim 8, wherein the header information further includes at least one of the number of compressed clusters included in the packing unit and a size of the compressed cluster.

10. A storage controller comprising:
a memory; and
one or more processors configured to function as a write controller and a readout controller,
wherein the write controller includes
a packing processor that generates a packing unit including a compressed cluster obtained by compressing write data and header information associating a logical address of the compressed cluster and position information, and
a write section that writes the packing unit into a non-volatile memory, and that updates management information associating the logical address of the compressed cluster and a physical address, and
wherein the readout controller includes
a conversion section that converts a logical address of a compressed cluster that is a readout target into the physical address in the non-volatile memory,
a readout section that reads out, from the non-volatile memory, data included in the packing unit at a position indicated by the physical address, and
an analysis section that analyzes header information included in the packing unit, in parallel to reading of the data included in the packing unit, and that acquires position information of the compressed cluster that is the readout target in the packing unit.

11. A computer program product comprising a non-transitory computer program for causing a computer to perform the steps of:
converting a logical address of a compressed cluster that is a readout target into a physical address in a non-volatile memory;
reading out, from the non-volatile memory, data included in a packing unit at a position indicated by the physical address; and
analyzing header information included in the packing unit, in parallel to reading of the data included in the packing unit, and acquiring position information of the compressed cluster that is the readout target in the packing unit.
